(19) United States
(12) Patent Application Publication
(10) Pub. No.: US 2026/0078282 A1
(43) Pub. Date: Mar. 19, 2026

(54) HEAT-SEALABLE ADHESIVE COMPOSITION AND USES THEREOF

(71) Applicant: Kemira Oyj, Helsinki (FI)

(72) Inventors: Ting Chen, Atlanta, GA (US); Yessica Perez-Sajche, Atlanta, GA (US); Bradley Bland, Atlanta, GA (US)

(21) Appl. No.: 18/889,086

(22) Filed: Sep. 18, 2024

(51) Int. Cl. C09J 7/35; C09J 7/21; C09J 11/04; C09J 11/08

(52) U.S. Cl. CPC C09J 7/35; C09J 7/21; C09J 11/04; C09J 11/08; C09J 2301/304; C09J 2301/408

(57) ABSTRACT

A heat-sealable adhesive composition comprises a polyhydroxyalkanoate and a booster. The polyhydroxyalkanoate is present in an amount of at least 40%. The booster is selected from: an acrylate-based polymer in an amount of 0.5 to 60%; a starch or modified starch in an amount of 0.1 to 30%; a PVOH or EVOH in an amount of 0.1 to 30%; a cellulose derivative in an amount of 0.1 to 10%; silica in an amount of 0.1 to 10%; and combinations thereof. The stated percentages are by weight of the composition on a dry matter basis. The booster improves one or more properties of the polyhydroxyalkanoate, such as the rate at which hot tack ramps up and/or the seal strength of the adhesive. Also provided is packaging including the adhesive composition, as well as methods of using the adhesive composition and the use of a booster in an adhesive composition.

### BACKGROUND

Heat-sealable adhesives and coatings are widely used in the packaging industry to form adhesive bonds between a broad variety of substrates, including paper, card, metal foils, and polymer films.

To manufacture a packaging material, a heat-sealable adhesive is formulated as a dispersion in a liquid medium, and the dispersion is then coated onto a substrate. Many different coating techniques may be used, including for example rod coating, blade coating, flexographic coating, gravure coating, spray coating, curtain coating, and air-knife coating. This is followed by a drying process to remove excess liquid.

The heat-sealable adhesive is then used to form an adhesive bond between two surfaces, by heating the adhesive to a sealing temperature and applying pressure. The strength of the adhesive bond is determined in part by the sealing temperature and the magnitude of the pressure, as well as the dwell time, i.e. the duration for which the heat and pressure is applied. For industrial-scale manufacturing processes, rapid bonding is highly desirable to allow a high throughput.

Heat-sealable adhesives may be water-based or solvent-based.

In general, water-based heat-sealable adhesives have less environmental impact and are safer to handle than solvent-based adhesives. In addition, water-based adhesives are generally more suitable for use in food packaging than solvent-based adhesives.

However, existing water-based adhesives typically include synthetic polymers derived from petrochemicals. These synthetic polymers have negative impacts on the environment, particularly at the end-of-life of the packaging material. Synthetic polymers are typically not compostable or biodegradable, and recycling packaging that includes a combination of a cellulosic substrate and a synthetic polymer poses a significant challenge.

There remains a need for a heat-sealable adhesive with good bonding properties and less environmental impact.

### SUMMARY

In one aspect, there is provided a heat-sealable adhesive composition comprising a polyhydroxyalkanoate and a booster. The polyhydroxyalkanoate is present in an amount of at least 40%. The booster is selected from an acrylate based polymer in an amount of 0.5 to 60%; a starch or modified starch in an amount of 0.1 to 30%; a polyvinyl alcohol (“PVOH”) or ethylene-vinyl alcohol (“EVOH”) in an amount of 0.1 to 30%; a cellulose derivative in an amount of 0.1 to 10%; silica in an amount of 0.1 to 10%; and combinations thereof. All of the stated percentages are by weight of the composition on a dry matter basis. It has been found that the inclusion of the booster improves the heat seal properties of the composition compared to PHA alone.

A related aspect provides an aqueous dispersion of the composition.

Another related aspect provides packaging comprising a substrate and the heat-sealable adhesive composition.

Still another aspect provides the use of a booster to improve the hot tack and/or heat seal strength of a heat-sealable adhesive composition, the heat-sealable adhesive composition being as defined herein.

A further aspect provides a method of forming an adhesive bond using a heat-sealable adhesive composition as defined herein. The method comprises arranging the heat-sealable adhesive composition between first and second regions to be bonded such that the first and second regions are each in contact with the heat-sealable adhesive composition; applying heat to the heat-sealable adhesive composition; and applying pressure to the heat-sealable adhesive composition. Applying the heat and the pressure cures the heat-sealable adhesive composition to form the adhesive bond between the first and second regions. Optionally, ultrasound may be applied simultaneously or sequentially to the heat and pressure. Applying ultrasound may improve sealing.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic cross-section of an example packaging material;

FIG. 2 is a flow diagram outlining a method of forming an adhesive bond;

FIG. 3 is a schematic diagram of an apparatus useful for implementing the method of FIG. 2;

FIG. 4A is a plot of peak hot tack as a function of seal temperature for composition 7 as described in the Examples;

FIG. 4B is a plot of seal strength as a function of seal temperature for composition 7;

FIG. 5A is a plot of peak hot tack as a function of seal temperature for composition 8;

FIG. 5B is a plot of seal strength as a function of seal temperature for composition 8;

FIG. 5C is a plot of peak hot tack as a function of seal pressure for composition 8;

FIG. 5D is a plot of peak seal strength as a function of seal pressure for composition 8;

FIG. 6A is a plot of peak hot tack as a function of seal temperature for composition 9;

FIG. 6B is a plot of seal strength as a function of seal temperature for composition 9;

FIG. 7A is a plot of peak hot tack as a function of seal temperature for composition 10;

FIG. 7B is a plot of seal strength as a function of seal temperature for composition 10;

FIG. 8A is a plot of peak hot tack as a function of seal temperature for composition 11;

FIG. 8B is a plot of seal strength as a function of seal temperature for composition 11;

FIG. 9A is a plot of peak hot tack as a function of seal temperature for composition 12;

FIG. 9B is a plot of seal strength as a function of seal temperature for composition 12;

FIG. 10A is a plot of peak hot tack as a function of seal temperature for composition 13;

FIG. 10B is a plot of seal strength as a function of seal temperature for composition 13;

FIG. 10C is a plot of peak hot tack as a function of seal pressure for composition 13;

FIG. 10D is a plot of seal strength as a function of seal temperature for composition 13;

FIG. 11A is a plot of peak hot tack as a function of seal temperature for composition for composition 14; and

FIG. 11B is a plot of seal strength as a function of seal temperature for composition 14.

### DETAILED DESCRIPTION

### General Definitions

The verb ‘to comprise’ is used herein as shorthand for ‘to include or to consist of’. In other words, although the verb ‘to comprise’ is intended to be an open term, the replacement of this term with the closed term ‘to consist of’ is explicitly contemplated, particularly where used in connection with chemical compositions.

A “biobased” material contains carbon, with at least 30%, preferably at least 50%, and most preferably all of the carbon in the material being derived from a renewable source. Carbon from renewable sources may be distinguished from carbon from fossil fuel sources by isotope analysis. Fossil fuel sources will be substantially free of ¹⁴C. Renewable sources will include ¹⁴C in a proportion approximately equal to the proportion present in the atmosphere, i.e. 1 to 2 ¹⁴C atoms per 1012 atoms of total carbon. Thus, a biobased material comprises at least 0.3 ¹⁴C atoms per 10¹² atoms of total carbon, and preferably 1 to 2 ¹⁴C atoms per 10¹² atoms of total carbon.

“Seal strength” is the force per unit width of a bond necessary to peel apart the bond.

Seal strength may be measured while the seal is still hot (“hot tack”), shortly after cooling the seal to ambient temperature (“green” seal strength), or after cooling and stabilizing the bond (“ultimate” or “aged” seal strength). Hot tack, green seal strength, and aged seal strength are both relevant in packaging processes.

All hot tack values reported herein are measured in accordance with Method B as described in ASTM standard F1921/F1921M-12, as updated on 5 Apr. 2023 (DOI: 10.1520/F1921_F1921M-12R18).

All green- and aged-heat seal strength values reported herein are measured in accordance with Technique B as described in ASTM standard ASTM F88/F88M-21, as updated on 3 Aug. 2023 (DOI: 10.1520/F0088_F0088M-21).

A “green bond strength” is a bond strength that is measured 1 minute after forming the bond.

An “aged bond strength” is a bond strength that is measured after the aging the bond for at least 48 hours under the conditions defined in Test Method TAPPI/ANSI T 402 sp-21 (i.e., a relative humidity of 50%, and a temperature of 23° C.).

As used herein, the terms “heat seal strength”, “seal strength”, and “bond strength” are synonymous.

A “repulpable” and “recyclable” describe products which are repulpable or recyclable within the meaning of Fibre Board Association's “Voluntary Standard For Repulping and Recycling Corrugated Fiberboard Treated to Improve Its Performance in the Presence of Water and Water Vapor” (Revised on Aug. 16, 2013).

A “compostable” product is a product that complies with ASTM D 6400 (23 Dec. 2022; DOI: 10.1520/D6400-21).

A “biodegradable” product complies with at least one of ASTM D5988 (DOI: 10.1520/D5988-18, updated 9 May 2018), ASTM D5271 (DOI: 10.1520/D5271-93, updated 16 Aug. 2017), and ASTM D6691 (DOI: 10.1520/D6691-17, updated 23 Apr. 2024).

Where not otherwise stated, all viscosity values are measured at 23° C. using a Brookfield RV viscometer with a #3 spindle operating at 100 rpm.

As used herein, the terms “bond” and “heat seal” are synonymous, and refer to a join or connection which is formed between two surfaces when a composition as defined herein is subjected to heat and pressure. The composition may provide adhesive and/or cohesive bonding between the surfaces.

Where not otherwise stated, all percentages are by weight on a dry matter basis. As an exception, solids contents of dispersions are expressed as percentages by weight based on the total weight of the dispersion including the solvent.

Relative directional terms such as “upper”, “lower”, “top”, and “bottom”, are used herein for convenience to describe the arrangement of components as illustrate in the relevant drawing(s). For the avoidance of any doubt, this terminology is not intended to limit orientation in an external frame of reference.

Where it is said that a first component (e.g. a first layer) is “on” a second component (e.g., a second layer), the first component is in direct contact with the second component. Where it is said that a first component is “over” a second component, the first component may be directly on the second component or there may be one or more further components between the first component and the second component.

The expression “acrylate-based polymer” is used synonymously with “acrylic polymer”, and refers to any acrylic polymer suitable for use in an adhesive composition. The polymer may be a homopolymer or a copolymer. Examples of acrylic monomers include acrylic acid; alkyl acrylic acids, such as methacrylic acid or ethyl acrylate; and acrylic esters, such as methyl acrylate, ethyl acrylate, butyl acrylate, 2-ethylhexyl acrylate, methyl methacrylate, and ethyl hexyl acrylate.

### Heat-Sealable Adhesive Composition

The heat sealability of various polyhydroxyalkanoates (“PHAs”) was investigated. It was found that a PHA used alone may form a seal bond with a seal initiation temperature at 94° C. and a minimum seal temperature at 96° C. However, PHAs used alone were found to have various drawbacks which made them unsuitable for industrial-scale use as heat-sealable adhesives.

The PHAs were dispersed in water and coated onto substrates. It was found that drying the coated layer required temperatures in excess of 140° C., which is very energy-intensive and limits the coating techniques which may be used. It was also found that it was necessary to coat both surfaces to be bonded with the PHA.

In use, the hot tack of the PHAs was found to build, i.e. ramp up, slowly. This led to the formation of weak and/or incomplete seals before the seals are cooled down to room temperature. Therefore, PHAs could not be used reliably in vertical form fill seal (“VFFS”) machines, which require hot tack to build quickly in order to enable continuous operation of the machine.

The seal strength values were found to be about 500 g/25 mm, which may be acceptable for some types of packaging, but which is too low for general use.

Seal strength was also found to drop significantly after aging for 24 hours or more.

Furthermore, the PHA dispersions adhered poorly to fiber-based substrates, resulting in picking and delamination of the coating.

The inventors have found that properties of PHAs may be improved by combining the PHAs with certain other components, referred to herein as boosters. The inventors developed recyclable biobased coatings/adhesives useful for providing heat sealability to a variety of substrates, such as paper, paperboard, molded fiber containers, and packaging films. Compositions provided herein may also have useful barrier properties, providing resistance against liquid water, water vapour, and/or oil and grease.

The packaging materials provided herein can be converted into many different forms of packaging, such as overwraps, mailers, pouches, and the like.

The heat-sealable adhesives provided herein contain a polyhydroxyalkanoate and one or more of the following boosters: starch, PVOH, EVOH, cellulose derivatives (e.g. methyl cellulose or hydroxypropyl methyl cellulose), silica, and acrylate polymers. Hot tack, seal strength, barrier properties, and environmental benefits may be tailored for different use cases by selecting the nature and amount of the boosters in the formulation.

The heat-sealable adhesives optionally further include one or more additives, which may be selected from rheology modifiers, anti-block agents, anti-slip agents, defoamers, biocides, surfactants, and plasticizers.

Heat-sealable adhesives provided herein may achieve a hot tack and bond strength ≥500 g/in, using sealing temperatures in the range 110° C. to 160° C. The coated substrates may be sealed using a variety of packaging machines, such horizontal form fill seal (“HFFS”) or vertical form fill seal (“VFFS”) packaging machines, pouch making machine, and the like.

Heat-sealable adhesives described herein may be used as lamination adhesives in multi-layer packaging structures.

The present disclosure provides a heat-sealable adhesive composition comprising a polyhydroxyalkanoate and a booster, wherein the polyhydroxyalkanoate is present in an amount of at least 40%; and wherein the booster is selected from: an acrylate-based polymer in an amount of 0.5 to 60%; starch or modified starch in an amount of 0.1 to 30%; PVOH or EVOH in an amount of 0.1 to 30%; a cellulose derivative in an amount of 0.1 to 10%; silica in an amount of 0.1 to 10%; and combinations thereof; all of the percentages being by weight of the composition on a dry matter basis.

The composition may have a peak hot tack of at least 450 g/25 mm, and optionally at least 700 g/25 mm, as measured in accordance with ASTM F1921/F1921M-12 (2018).

The composition may be a biobased composition. The composition may be recyclable and/or repulpable and/or compostable.

The nature of the polyhydroxyalkanoate is not particularly limited. The inventors investigated various commercially-available grades of polyhydroxyalkanoate and observed improvements in heat seal properties.

For example, the polyhydroxyalkanoate may be a semicrystalline polyhydroxyalkanoate.

The polyhydroxyalkanoate is optionally made up of monomers selected from hydroxybutyrate, hydroxy valerate, hydroxyhexanoate, hydroxyoctanoate, hydroxydecanoate, and combinations thereof. The polyhydroxyalkanoate may be a homopolymer or a copolymer. Mixtures of two or more different polyhydroxyalkanoates may be used.

An example polyhydroxyalkanoate copolymer is poly-3-hydroxybutyrate-co-3-hydroxyhexanoate (“P(3HB-co-3HHx)”). Further optionally, the P(3HB-co-3HHx) may be made up of 85 to 95 mol % hydroxybutyrate and 5 to 15 mol % hydroxyhexanoate.

Further examples of polyhydroxyalkanoate copolymers include those made up of two to four monomers selected from hydroxy valerate, hydroxyhexanoate, hydroxyoctanoate, and hydroxydecanoate, each of the monomers being present in an amount of at least 25 mol %.

Still further examples of polyhydroxyalkanoates include terpolymers made up of three different types of hydroxyalkanoate monomer residues. For example, the terpolymer may include from 75 to 99 mol % hydroxybutyrate, from 0.1 to 15 mol % hydroxyvalerate, and from 1 to 25 mol % of a third hydroxyalkanoate, such as hydroxyhexanoate.

The polyhydroxyalkanoate optionally has a weight average molecular weight of 50,000 Daltons to 2.5 million Daltons. Optionally, the weight average molecular weight is 150,000 Daltons to 600,000 Daltons. Further optionally, the weight average molecular weight is 150,000 Daltons to 500,000 Daltons.

The polyhydroxyalkanoate may be present in an amount of at least 45%.

The polyhydroxyalkanoate may be present in an amount of 45 to 75%, particularly in implementations in which the booster comprises an acrylate copolymer, an acrylate polymer, or a combination thereof. For example, the polyhydroxyalkanoate may be present in an amount of 45 to 65%, optionally 45 to 55%, and further optionally 48 to 52%.

Alternatively, the polyhydroxyalkanoate may be present in an amount of at least 70%, particularly in implementations where the booster comprises a cellulose derivative or silica. For example, the polyhydroxyalkanoate may be present in an amount of at least 80% or at least 90%. Optionally, the polyhydroxyalkanoate may be present in an amount of 94 to 98%.

The booster comprises one or more of: an acrylate-based polymer in an amount of 0.5 to 60%; starch or modified starch in an amount of 0.1 to 30%; PVOH or EVOH in an amount of 0.1 to 30%; a cellulose derivative in an amount of 0.1 to 10%; a cellulose derivative in an amount of 0.1 to 10%; and silica in an amount of 0.1 to 10%.

Typically, the heat-sealable adhesive composition includes one booster, although the use of two or more boosters in combination is contemplated. For example, the heat-sealable adhesive composition may include an acrylate-based polymer together with a cellulose derivative and/or silica.

Preferably, the booster includes an acrylate-based polymer. The total amount of acrylate-based polymer and acrylate polymer is typically in the range 0.5 to 60%, most typically 5 to 60%, however lower amounts of acrylate-based copolymer may be used especially in implementations where the composition includes two or more boosters.

The acrylate-based polymer is preferably a biobased polymer.

The acrylate-based polymer may be present in the composition in an amount of 25 to 50%, optionally 35 to 50%, and further optionally 45 to 50%. In particular, the acrylate polymer, acrylate copolymer, or mixture thereof may be present in an amount of 48 to 50%.

The nature of the acrylate-based polymer is not particularly limited provided that the acrylate-based polymer is suitable for inclusion in an adhesive composition. Useful acrylate polymers and acrylate copolymers including those having a viscosity of less than or equal to 1,000 mPa·s as measured at 23° C. using a Brookfield RV viscometer with a #3 spindle operating at 100 rpm when the acrylate polymer and/or acrylate copolymer is dispersed in water to form an aqueous dispersion, suspension, or emulsion having a solids content in the range 30 to 60% by total weight of the aqueous dispersion, suspension, or emulsion.

A composition which includes an acrylate-based polymer optionally further comprises a wax. It has been found that the combination of an acrylate polymer and/or acrylate copolymer with a wax may further enhance heat seal properties.

The nature of the wax is not particularly limited. The wax may be a plant wax, an animal wax, a plant-based wax, or an animal-based wax. Preferably, the wax is a plant wax or plant-based wax.

Examples of plant waxes and plant-based waxes include palm oil-based wax, coconut oil based-wax, candelilla wax, carnauba wax, rice bran wax, soybean wax, sugar cane wax, sunflower wax, canola wax, rapeseed wax, and mixtures thereof. Preferably, the wax is selected from palm oil-based wax, coconut oil-based wax, and mixtures thereof.

The wax may be present in an amount of 0.01 to 5%, optionally 0.01 to 1%.

The booster may alternatively or additionally comprise a cellulose derivative. The cellulose derivative may be present in the composition in an amount of 0.1 to 10%. Optionally, the cellulose derivative may be present in an amount of 0.5 to 6%, further optionally 1 to 3%.

Cellulose is a linear polymer made up of β(1→4) linked D-glucose monomers. In a “cellulose derivative”, some of the OH groups that are present in cellulose are replaced with other substituents. A “cellulose derivative” may in particular have a structure of formula:

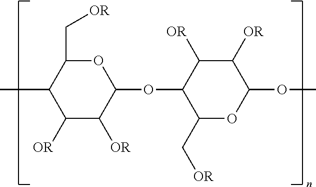

wherein each R is independently selected from H, a C1-C6 alkyl group, a C1-C6 hydroxyalkyl group, and a C1-C6 carboxyalkyl group; with the proviso that not all of the R groups are H.

The value of n is not particularly limited, and may vary depending upon the source of the cellulose. The value of n is typically range 10 to 100,000, e.g. 200 to 20,000, or 250 to 2,500.

It will be appreciated that each R group in the entire molecule may be independently selected. The average number of substituents per glucose monomer is referred to as the degree of substitution. The degree of substitution may be greater than or equal to 0.1, optionally greater than or equal to 0.5, further optionally greater than or equal to 1. The maximum possible degree of substitution is 3.

The cellulose derivative may be a cellulose ether. In particular, the cellulose derivative may be a cellulose ether bearing substituents selected from alkyl groups, hydroxyalkyl groups, carboxyalkyl groups, and combinations thereof. For example, the cellulose ether may be selected from alkyl celluloses, such as methyl cellulose or ethyl cellulose; hydroxyalkylcelluloses, such as hydroxymethyl cellulose or hydroxyethylcellulose; and carboxyalkylcelluloses, such as carboxymethylcellulose.

Preferred cellulose ethers include methyl cellulose and hydroxypropylmethyl cellulose.

For example, the composition may comprise hydroxypropylmethyl cellulose in an amount of 0.1 to 0.5%, optionally 0.3 to 0.4%.

Alternatively, the cellulose derivative may be a cellulose ester. Examples of cellulose esters include cellulose acetate and cellulose acetate butyrate.

The cellulose derivative has a viscosity in the range 3 to 10,000 mPa·s as measured at 23° C. using a Brookfield RV viscometer with a #3 spindle operating at 100 rpm when dissolved in water at a concentration of 2% by weight based on the total weight of the resultant solution.

The cellulose derivative may be present in combination with an acrylate-based polymer. In such implementations, the acrylate-based polymer may be present in the composition in an amount of 0.5 to 10%, 25 to 45%, 25 to 35%, or 35 to 45%.

The booster may alternatively or additionally comprise silica. The silica may be present in the composition in an amount of 0.1 to 10%, optionally 2 to 8%, further optionally 3 to 7%. Preferably, the silica may be present in an amount of 4 to 6%.

The silica may be in the form of finely-divided particles. For example, the silica may be fumed silica or precipitated silica.

In addition to the polyhydroxyalkanoate and the booster, the composition may further comprise an effective amount of one or more additives. Examples of additives include pH adjusters, rheology modifiers, anti-block agents, anti-slip agents, defoamers, biocides, surfactants, and plasticizers.

The pH adjuster may be any suitable acid (e.g., hydrochloric acid) or base (e.g., sodium hydroxide). A pH adjuster may in particular be present when the composition is formulated as an aqueous dispersion. The amount of pH adjuster may be selected as appropriate to bring the pH of the dispersion into a desired range, e.g. pH 7.5 to 8.5, optionally 7.8 to 8.5.

Examples of anti-block and anti-slip agents include clay and talc. The amount of anti-block agent may be in the range 0.1 to 15%. The amount of anti-slip agent may be in the range 0.1 to 3%.

The rheology modifier may be present in an amount of 0.1 to 5%. The rheology modifier may be a polysaccharide, a viscosity depressant, or a viscosity enhancer. Viscosity depressants and viscosity enhancers are commercially available.

Examples of surfactants include polysorbates, aromatic polyethylene oxides, sorbitan derivatives, block copolymers of poly(ethylene oxide) and polypropylene oxide), poly(glycol ethers), poly(vinyl alcohol), alkyl sulfates, alkyl phosphates, stearates, and mixtures thereof. The surfactant may be present in an amount of 0.01 to 5%.

Examples of plasticizers include sebacates; citrates; fatty esters of adipic, succinic, and glucaric acids; lactates; alkyl diesters; alkyl methyl esters; dibenzoates; propylene carbonate; caprolactone diols having a number average molecular weight from 200-10,000 g/mol; poly(ethylene) glycols having a number average molecular weight of 400-10,000 g/mol; esters of vegetable oils; long chain alkyl acids; adipates; glycerol; and mixtures thereof. A plasticizer may be present in an amount of 0.5 to 15%.

The composition may be provided in the form of a dispersion in a suitable liquid medium. This may allow the composition to be applied to a substrate using a variety of different coating techniques. The liquid medium is most preferably water, since water has less environmental impact than organic solvents. However, an organic solvent or a mixture of water and an organic solvent may be used in principle.

The composition may be in the form of an aqueous dispersion. The aqueous dispersion typically has a pH of at least 6, and preferably has a pH in the range 7.5 to 8.5. It has been found that dispersions having pHs of at least 6 are more stable than dispersions having pHs below 6.

The solids content of the dispersion may be selected to allow a layer of the adhesive composition having a suitable coating weight to be formed in a single coating operation. The solids content is desirably as high as possible, provided that handling properties such as viscosity and stability remain within acceptable ranges for the coating process chosen. The coating process is not particularly limited, and may for example be selected from rod, blade, flexography, gravure, spray, curtain, and air-knife coating. A solids content in the range 30 to 50% by weight of the dispersion may provide a good balance between coating weight and handling properties.

The aqueous dispersion may have a viscosity in the range 100 to 1,000 mPa·s as measured at 23° C. using a Brookfield RV viscometer with a #3 spindle operating at 100 rpm.

The composition may be used to form a bond (e.g., an adhesive bond). The bond may have a peak green bond strength of at least 300 g/25 mm, optionally at least 500 g/25 mm, and further optionally at least 800 g/25 mm as measured in accordance with Technique B of ASTM F88/F88M-23.

The bond may have a peak aged bond strength of at least 300 g/25 mm, optionally at least 500 g/25 mm, further optionally at least 800 g/25 mm as measured in accordance with Technique B of ASTM F88/F88M-23, the aged bond strength being measured 48 hours after forming the bond.

### Packaging Including the Heat-Sealable Adhesive Composition

Another aspect provides packaging comprising a substrate and a heat-sealable adhesive composition as defined herein.

The substrate may comprise any suitable material. Preferably, the substrate is a biobased substrate. For example, the substrate may comprise a cellulosic substrate, such as paper, paperboard, cardboard, or moulded fibre. Additional examples of substrates include textiles and polymer films.

The substrate may include a barrier layer. For example, the substrate may include a cellulosic substrate and a barrier layer arranged over the cellulosic substrate. The heat-sealable adhesive composition may be arranged between the cellulosic substrate and the barrier layer. Alternatively, the heat-sealable adhesive composition may be arranged over the cellulosic substrate and the barrier layer. In accordance with another possibility, the barrier layer and the heat-sealable adhesive composition may be arranged on opposite faces of the cellulosic substrate.

When present, the nature of the barrier layer is not particularly limited. Examples of barrier layers include a water barrier, a water vapor barrier, a gas barrier, aroma barrier, and an oil and grease resistant barrier. As will be appreciated, certain barrier layers may be effective against a combination of two or more of liquid water, water vapour, gas, aroma, oil, and grease. For example, the barrier layer may be a metal layer.

The inclusion of a barrier layer is optional. Usefully, heat-sealable adhesive compositions as described herein have been found to act as barriers against at least water, oil, and grease. When a barrier layer is included, the barrier layer may supplement the barrier properties of the heat-sealable adhesive. A barrier layer is also useful in implementations where the heat-sealable adhesive composition does not cover a full surface of the substrate.

The packaging may further comprise a printed layer. In such implementations, the heat-sealable adhesive composition may be arranged on the printed layer. Alternatively, the heat sealable adhesive composition and the printed layer may be arranged on opposite faces of the cellulosic substrate.

The heat-sealable adhesive composition may be in the form of a layer over the substrate. For example, the packaging may have a laminated structure, in which the layer of the heat-sealable adhesive composition is interposed between the substrate and a further layer.

When the heat-sealable adhesive composition is in the form of a layer, the layer may have a coat weight in the range 2 to 20 gsm. The layer may be formed in one or more coating operations, optionally one or two coating operations, and preferably exactly one coating operation.

The heat-sealable adhesive may be configured for sealing closed the packaging. For example, the heat-sealable adhesive may be arranged as a strip, a net, one or more dots, or in any other form.

The nature of the packaging is not particularly limited. For example, the packaging may be a sheet of material, which may be further processed (e.g., cut and/or folded) into a suitable form.

The packaging may be a flexible package. Examples of flexible packages include bags, pouches, sachets, flow wraps, wrappers, pillow bags, and standup pouches. The packaging may be configured for filling and sealing using a packaging machine, optionally a packaging machine selected from a horizontal form fill seal packaging machine; a vertical form fill seal packaging machine; and a pouch making machine.

The adhesive composition is also useful for attaching a flexible lid to a container.

In accordance with still another possibility, the adhesive composition is used to seal together a paper container, such as a cup, a tub, or a bowl.

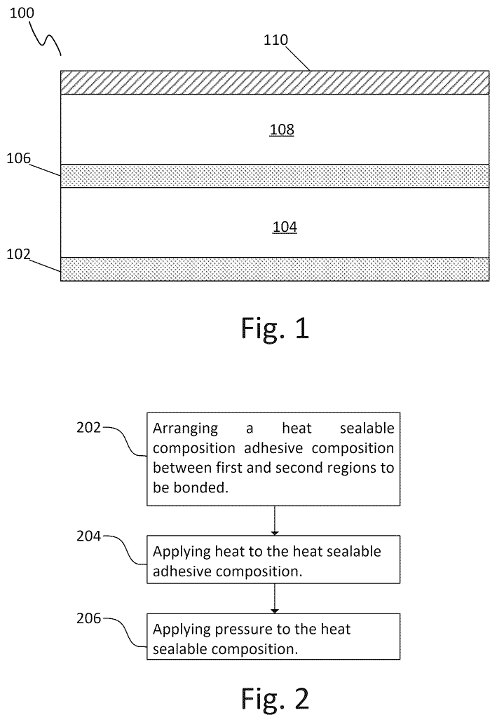

An example packaging material 100 is illustrated in FIG. 1. FIG. 1 is a schematic cross-section of the packaging material 100.

Packaging material 100 has a laminate structure. The laminate includes a first heat-sealable adhesive layer 102, comprising a heat-sealable adhesive composition as defined herein. When the material is assembled into a package such as pouch, bag, or the like, the first heat-sealable adhesive layer 102 may be an inner surface of a package. Part of the first heat-sealable adhesive layer may be used to seal the package. Heat-sealable adhesive compositions as provided herein may have barrier properties. Heat-sealable adhesive layer 102 may therefore reduce diffusion of water, water vapour, oil, and/or grease into or out of the package.

A first substrate layer 104 is arranged on the first heat-sealable adhesive layer 102. The nature of first substate layer 104 is not particularly limited, and may be selected from any of the various substrate materials discussed herein. For example, the first substrate layer 104 may comprise a cellulosic material or a polymer film.

A second heat-sealable adhesive layer 106 is arranged on the first substrate layer 104, and a second substrate layer 108 is arranged on the second heat-sealable adhesive layer 106. The material of the second substrate layer 108 is not particularly limited, and may the same as or different from the material of the first substrate layer 104. The second heat-sealable adhesive layer 106 provides an adhesive bond between the first and second substrate layers 104, 108.

A printed layer 110 is arranged on a top surface of second substrate layer 108. When the material is assembled into a package, printed layer 110 may be an outer layer of the package.

Various modifications may be made of the example packaging material. The number of layers, the nature of the layers, and the order of the layers may be varied as desired depending upon the intended use of the packaging material.

For example, the first heat-sealable adhesive layer 102 and/or the printed layer 110 may be omitted. The first heat-sealable adhesive layer 102 and the first substrate layer 104 may be omitted. Alternatively, or additionally, further layers such as a barrier layer may be added.

Although depicted as a continuous layer in FIG. 1, in some implementations the first heat-sealable adhesive layer 102 need not necessarily cover the entire bottom surface of the first substrate layer 104. The first heat-sealable adhesive layer may alternatively be configured as one or more strips, dots, or in any other shape.

Printed layer 110 may be coated with a further layer of heat-sealable adhesive composition.

### Uses of Boosters

Another aspect provides the use of a booster to improve the hot tack and/or heat seal strength of a heat-sealable adhesive composition. The heat-sealable adhesive composition and the booster are as defined herein.

The booster may increase the rate at which hot tack ramps up, i.e. builds. In other words, the hot tack of a composition including the booster may increase more quickly than that of a control composition, under identical conditions. The control composition differs from the composition of the present disclosure only in that the control composition does not include the booster. A fast hot tack ramp-up is desired when running the packaging machine at high speed.

The heat seal strength may be a green heat seal strength. Green heat seal strength is measured after 1 minute of forming the adhesive bond.

Alternatively, the heat seal strength may be an aged heat seal strength. Aged heat seal strength is measured 48 hours or more after forming the adhesive bond.

The use of the booster may improve the heat seal strength by at least 5%, optionally at least 10%. For example, the booster may improve the heat seal strength by 5 to 60%. The improvement is relative to a control composition that differs from the composition of the present disclosure only in that the control composition does not include the booster.

### Methods of Using the Heat-Sealable Adhesive Composition.

An example method of forming a bond using the heat-sealable adhesive composition of the present disclosure will now be described with reference to FIG. 2. FIG. 2 is a flow diagram outlining the method.

The method includes, at block 202, arranging the heat-sealable adhesive composition between first and second regions to be bonded, such that the first and second regions are each in contact with the heat-sealable adhesive composition.

The nature of the first and second regions is not particularly limited, provided that the regions are capable of being bonded using the heat-sealable adhesive composition.

The regions may be present on two different substrates. Alternatively, the first and second regions may both be present on the same substrate, with the substrate being folded to bring the first and second regions into contact with one another.

The heat-sealable adhesive composition may be provided on at least one of the first and second regions in advance.

Alternatively, the method may further comprise, before the arranging, applying the heat-sealable adhesive composition to at least one of the first and second regions.

The applying may comprise flood-coating. Flood-coating may cover substantially all of a surface of a substrate with the heat-sealable adhesive composition.

Alternatively, the heat-sealable adhesive composition may be applied to a selected region. In such implementations, the heat-sealable adhesive composition may be arranged as a strip, a net, one or more dots, or in any other suitable configuration.

Conveniently, the heat-sealable adhesive composition may be applied in the form of an aqueous dispersion of the composition. The aqueous dispersion may be as described herein. Aqueous dispersions are compatible with a broad range of coating techniques.

The heat-sealable adhesive composition may be applied using any suitable technique. Examples include rod coating, blade coating, flexographic coating, gravure coating, spray coating, curtain coating, and air-knife coating.

The method further includes, at block 204, applying heat to the heat-sealable adhesive composition.

The heat is applied so as to increase the temperature of the heat-sealable adhesive composition to a temperature greater than or equal to a threshold temperature. The threshold temperature may be the minimum seal temperature, MST, for the composition. The MST is the minimum temperature necessary to achieve a seal strength of at least 200 g/25 mm. Alternatively, the threshold temperature may be the seal initiation temperature, SIT, which is the minimum temperature necessary to obtain a seal strength of at least 125 g/25 mm as measured in accordance with ASTM F2029.

The amount of heat to be applied may vary depending upon the levels of hot tack and seal strength needed. The amount of heat applied also influences the strength of the bond. This means that the amount of heat applied varies depending upon the purpose of the adhesive bond.

Typically, applying the heat comprises heating the adhesive composition to a temperature of at least 90° C. Although there is no particular upper limit on the temperature, in most implementations the temperature of the adhesive composition does not exceed 275° C.

For example, applying the heat may comprise heating the adhesive composition to a temperature in the range 90° C. to 200° C., optionally 110 to 160° C., and further optionally 130 to 160° C.

The heat may be applied using any appropriate technique, for example using a hot hair blower, a heated platen, or a heated roller.

The method also includes applying pressure to the heat-sealable adhesive composition, at block 206. Applying the heat and the pressure activates and cures the heat-sealable adhesive composition to form the adhesive bond between the first and second regions.

The booster may improve the hot tack and/or heat seal strength of the adhesive in comparison with an adhesive that does not include the booster.

The heat and pressure may be applied simultaneously. For example, the heat and pressure may be applied using a heated platen or heated roller.

Alternatively, the heat may be applied before the pressure. As will be appreciated, in such implementations, the pressure is applied before the adhesive composition cools.

Optionally, ultrasound may be applied to the adhesive composition, either simultaneously or sequentially to the heat and pressure. Applying ultrasound may improve sealing.

The heat and/or pressure is applied for a dwell time that allows for formation of the bond. The dwell time may be selected as appropriate depending upon the magnitude of the pressure and the temperature to which the adhesive composition is heated. In implementations where the heat and pressure are applied using a packaging machine, the dwell time chosen may also be based on the packaging rate of the machine.

Typically, the pressure is applied for a dwell time of at least 0.01 seconds, optionally at least 0.1 seconds. For example, the pressure may be applied for a dwell time of 0.01 to 1 seconds, optionally 0.25 to 0.75 seconds, further optionally about 0.5 seconds.

The magnitude of the pressure is not particularly limited provided that a bond having a desired strength is obtained. Applying the pressure may comprise applying a pressure of at least 40 psi, and optionally at least 80 psi. For example, applying the pressure may comprise applying a pressure of 150 to 250 psi, optionally 175 to 225 psi, or about 200 psi.

The method may be implemented using any suitable apparatus. For example, the heat and pressure may be applied using packaging machine. Examples of packaging machines include a horizontal form fill seal packaging machine; a vertical form fill seal packaging machine; and a pouch making machine.

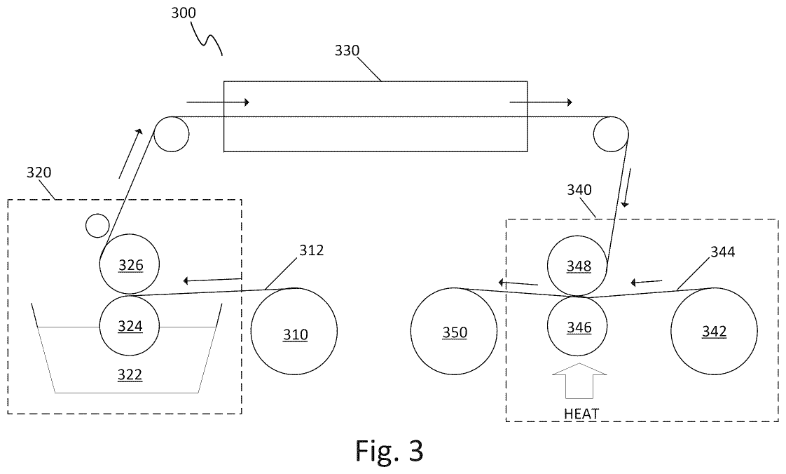

An apparatus useful for implementing the method of FIG. 2 will now be explained with reference to FIG. 3. FIG. 3 is a schematic diagram of the apparatus 300.

Apparatus 300 is a dry lamination apparatus, useful for manufacturing a packaging material comprising two sheets which are adhesively bonded using the heat-sealable composition as described herein.

The apparatus 300 comprises an unwinding roller 310, a gravure coating system 320, a dryer 330, and a laminating system 340 arranged in series.

Unwinding roller 310 is configured to unwind a substrate 312 from a roll and to deliver the substrate material 312 to the gravure coating system 320. The substrate 312 is in the form of a sheet and may comprise any of the materials identified herein with reference to the packaging material.

The gravure coating system 320 applies a layer of a heat-sealable adhesive composition to the substrate 312. The gravure coating system 320 comprises a bath 322, a coating roller 324, and a pressure roller 326.

The bath 322 holds a suspension of a heat-sealable adhesive composition in a suitable solvent, most typically water. The heat-sealable adhesive composition is as defined herein. The coating roller 324 is partially submerged in the suspension such that rotation of the coating roller 324 transfers the suspension from the bath 322 onto a bottom surface of the substrate 312 to form a coated layer on the substrate 312. Pressure roller 326 contacts a top surface of the substrate 312, thereby holding the substrate 312 in contact with the coating roller 324.

After the heat-sealable adhesive composition is applied onto the substrate 312, the substrate 312 passes through a dryer 330. The dryer removes excess solvent from the coated layer. The dryer may apply heat to drive off the solvent, for example by applying infrared radiation to the substrate and/or a flow of hot air over the substrate.

After passing through the dryer 330, the substrate 312 arrives at laminating system 340. Laminating system 340 comprises a second unwinding roller 342 and a pair of nip rollers 346, 348.

The substrate 312 is delivered to the upper nip roller 348 with the coated layer of adhesive composition facing outwardly from the upper nip roller 348. At the same time, the second unwinding roller 342 delivers a second sheet of material 344 to the lower nip roller 346. The coated layer is brought into contact with the second sheet 344 between the pair of nip rollers 346, 348. The nip rollers apply pressure to the coated layer of adhesive composition.

At least one of the nip rollers 346, 348 is heated, so as to heat the coated layer of adhesive composition to a temperature greater than or equal to its minimum sealing temperature.

The action of the nip rollers cures the layer of heat-sealable adhesive composition, which is arranged between the substrate 312 and the second sheet 344. This yields a laminate.

The laminating system 340 then delivers the laminate to a product collection roller 350.

Various modifications may be made to the described apparatus.

For example, gravure coating system 320 may be replaced with any suitable coating system. Further examples of suitable coating systems include rod, blade, flexographic, spray, curtain, and air-knife coaters.

Moreover, as will be appreciated, the methods described herein may be implemented using alternative apparatuses. The packaging material is not necessarily in the form of a laminate.

### EXAMPLES

### Example 1: Heat-sealable Adhesive Compositions

Table 1 sets out general details of formulations provided herein.

TABLE 1
general formulations

| | | Amount/Dry |
|---|---|---|
| Ingredients | | wt. % |
| PHA dispersion | | 48-98.8 |
| Booster for | Cellulose derivative (e.g. methyl | 0.1-10 |
| hot tack and | cellulose, hydroxyl methyl cellulose, | |
| heat seal | etc.) | |
| | Silica | 0.1-10 |
| | Starch or modified starch | 0.1-30 |
| | PVOH or EVOH | 0.1-30 |
| | Acrylate polymer | 0.1-50 |
| Additives | Rheology modifier | 0-5 |
| | Anti-block agent | 0-10 |
| | Anti-slip agent | 0-3 |
| | NaOH | pH adjustment |
| | Defoamer | 0-1 |
| | Biocide | 0-1 |
| | Surfactant | 0-5 |
| | Plasticizer | 0-5 |

Aqueous dispersions of twelve heat-sealable adhesive compositions including boosters were prepared. Two comparative compositions, each consisting of a different commercially-available polyhydroxyalkanoate dispersed in water, were also tested. The compositions are identified in Table 2.

TABLE 2
tested compositions

| | Amount | | Amount of | | Amount of | |
|---|---|---|---|---|---|---|
| | of PHA / | | Booster / | | additives / | Environmental |
| # | % | Booster | % | Additives | % | benefits |
| 0 | 100 | (None) | | (None) | | Biobased, |
| | | | | | | Biodegradable, |
| | | | | | | Compostable, |
| | | | | | | Repulpable, |
| | | | | | | Recyclable |
| 1 | 50.99 | Biobased | 48.99 | NaOH | 0.02 | Biobased, |
| | | acrylate | | | | Repulpable, |
| | | polymer | | | | Recyclable |
| 2 | 49.75 | Acrylate | 49.75 | Rheology | 0.38 | Repulpable, |
| | | polymer | | modifier | | Recyclable |
| | | | | NaOH | 0.11 | |
| 3 | 50.96 | Acrylate | 48.96 | Rheology | 0.06 | Biobased, |
| | | polymer | | modifier | | Repulpable, |
| | | | | NaOH | 0.02 | Recyclable |
| 4 | 95.24 | Silica | 4.76 | | | Biobased, |
| | | | | | | Repulpable, |
| | | | | | | Recyclable |
| 5 | 94.95 | Hydroxypropyl | 5.03 | NaOH | 0.02 | Biobased, |
| | | methylcellulose | | | | Biodegradable, |
| | | | | | | Compostable, |
| | | | | | | Repulpable, |
| | | | | | | Recyclable |
| 6 | 97.83 | Methylcellulose | 2.15 | NaOH | 0.02 | Biobased, |
| | | | | | | Biodegradable, |
| | | | | | | Compostable, |
| | | | | | | Repulpable, |
| | | | | | | Recyclable |
| 7 | 100 | (None) | | (None) | | Biobased, |
| | | | | | | biodegradable, |
| | | | | | | Compostable, |
| | | | | | | Repulpable, |
| | | | | | | Recyclable |
| 8 | 49.83 | Acrylate | 49.83 | Rheology | 0.24 | Biobased, |
| | | polymer | | modifier | | Repulpable, |
| | | | | NaOH | 0.07 | Recyclable |
| 9 | 69.81 | Acrylate | 29.92 | NaOH | 0.02 | Biobased, |
| | | polymer | | | | Repulpable, |
| | | HPMC | 0.25 | | | Recyclable |
| 10 | 59.83 | Acrylate | 39.89 | NaOH | 0.03 | Biobased, |
| | | polymer | | | | Repulpable, |
| | | Hydroxypropyl | 0.25 | | | Recyclable |
| | | methylcellulose | | | | |
| 11 | 98.8 | Acrylate | 1 | NaOH | 0.1 | Biobased, |
| | | polymer and | | | | Repulpable, |
| | | copolymer | | | | Recyclable |
| | | Hydroxypropyl | 0.1 | | | |
| | | methylcellulose | | | | |
| 12 | 91.96 | Acrylate | 7.78 | NaOH | 0.01 | Biobased, |
| | | polymer | | | | Biodegradable, |
| | | Hydroxypropyl | 0.25 | | | Compostable, |
| | | methylcellulose | | | | Repulpable, |
| | | | | | | Recyclable |
| 13 | 89.16 | Starch | 6.15 | Clay | 4.51 | Biobased, |
| | | | | Rheology | 0.16 | Biodegradable, |
| | | | | modifier | | Compostable, |
| | | | | NaOH | 0.02 | Repulpable, |
| | | | | | | Recyclable |
| 14 | 88.85 | PVOH | 6.22 | Clay | 4.51 | Biobased, |
| | | | | Rheology | 0.33 | Biodegradable, |
| | | | | modifier | | Compostable, |
| | | | | NaOH | 0.09 | Repulpable, |
| | | | | | | Recyclable |

Compositions 0 and 7 are comparative examples. Compositions 0 and 7 each comprised a respective different grades of PHA dispersion.

### Example 2: Hot Tack

The peak hot tack of the test compositions of Example 1 were determined in accordance with industrial standard ASTM F1921. The results are reported in Table 3, below.

In the present example, a single coat of adhesive was used, at the coating weight indicated in the table. The sealing temperature was about 149° C. (300° F.), the seal pressure was 200 psi, the dwell time was 0.5 s, the cooling time was 0 s, and the peeling rate was 0.2 in/s.

Peak hot tack is the maximum force taken to separate or peel apart two sealed surfaces.

It is common in the packaging industry to report the peak value only, because in practice peak force is often the more relevant parameter. Further details are provided in the ASTM standard cited above.

TABLE 3
hot tack of the example compositions

| | | | Peak Hot Tack |
|---|---|---|---|
| Composition | Substrate | Coat weight/gsm | (g/25 mm) |
| 0 | 90 gsm paper | 14.4 | Not detected within |
| | | | the seal area |
| 1 | 90 gsm paper | 14.22 | 1082 |
| 2 | 90 gsm paper | 14.61 | 1233 |
| | 90 gsm paper | 11.24 | 1100 |
| | 65 gsm paper | 13.33 | 983 |
| 3 | 90 gsm paper | 11.35 | 1057 |
| 4 | 90 gsm paper | 15.5 | 912 |
| 5 | 90 gsm paper | 15.4 | 767 |
| 6 | 90 gsm paper | 16.62 | 500 |

The hot tack of the control composition, composition 0, increased too slowly to allow a measurement.

The above findings demonstrate that all of the boosters tested increased the rate at which hot tack formed. Compositions including an acrylate copolymer or silica booster achieved high hot tack strengths, demonstrating that these compositions are suitable for general use (e.g., for sealing bags of heavy items). Compositions 5 and 6, comprising cellulose derivatives as boosters, provided a level of hot tack suitable for light-duty applications (e.g., sealing bags of lightweight items).

### Example 3: Green Bond Strength

The peak green bond strengths of the compositions of Example 1 were measured in accordance with ASTM F88. Peak heat seal strength is the maximum force taken to separate/peel the two sealed surfaces.

A seal temperature of 300° F. (149° C.), a seal pressure of 200 psi, a dwell time of 0.5 s, a cooling time of 1 min and a peeling rate of 0.2 in/s were used in the experiment.

The results are set out in Table 4.

TABLE 4
green bond strengths of the compositions

| | | | Peak green bond |
|---|---|---|---|
| Composition | Substrate | Coat weight/gsm | strength (g/25 mm) |
| 0 | 90 gsm paper | 14.4 | 703 |
| 1 | 90 gsm paper | 14.22 | 1132 |
| 2 | 90 gsm paper | 14.61 | 1066 |
| | 90 gsm paper | 11.24 | 1274 |
| | 65 gsm paper | 13.33 | 1175 |
| 3 | 90 gsm paper | 11.35 | 1278 |
| 4 | 90 gsm paper | 15.5 | 782 |
| 5 | 90 gsm paper | 15.4 | 704 |
| 6 | 90 gsm paper | 16.62 | 825 |

Compositions 1, 2, 3, 4, and 6 were found to have improved green bond strength relative to the control composition.

### Example 4: Aged Bond Strength

Aged bond strengths were measured in accordance with the method of Example 3, this time allowing an ageing time of ≥2 days. The results are reported in Table 5.

TABLE 5
aged bond strengths of the compositions

| | | | Peak aged bond |
|---|---|---|---|
| Composition | Substrate | Coat weight/gsm | strength (g/25 mm) |
| 1 | 90 gsm paper | 14.22 | 839 |
| 2 | 90 gsm paper | 14.61 | 959 |
| | 90 gsm paper | 11.24 | 895 |
| | 65 gsm paper | 13.33 | 797 |
| 3 | 90 gsm paper | 11.35 | 971 |
| 5 | 90 gsm paper | 15.4 | 652 |

### Example 5: Moisture Barrier Properties

The water absorbance of layers of the control composition and compositions 1 and 2 were measured using the Cobb 300 test, a Cobb test using a contact time of 300 seconds.

The water absorbance of substrates coated with compositions 1 and 2 were found to be less than 5 gsm. These results demonstrated that the coated layers have excellent barrier properties.

The control composition was also found to have good barrier properties. The amount of water absorbed through the control composition was only slightly higher. However, the control layer required a much higher drying temperature than the layers of compositions 1 and 2.

### Example 6: Qualitative Summary

A qualitative summary of the results of Examples 2 to 5 is set out in Table 6.

In Table 6, ● denotes excellent performance (e.g., a peak green heat seal strength ≥1,000 g/25 mm, or a Cobb 300 result <5 gsm); [symbol] denotes good performance (e.g., a peak heat seal strength of in the range 800 to 999 g/25 mm), [symbol] denotes acceptable performance (e.g., a peak heat seal strength of in the range 500 to 799 g/25 mm); [symbol] denotes poor performance that may be workable for certain use cases (e.g., a peak heat seal strength in the range 300 to 499 g/25 mm), and ∘ denotes very poor performance (e.g. a peak heat seal strength of less than 300 g/25 mm).

TABLE 6
qualitative summary of results

| | | Coat | Cobb | | Green | Aged |
|---|---|---|---|---|---|---|
| | | weight / | 300 / | Hot | Bond | Bond |
| # | Substrate | gsm | gsm | Tack | Strength | Strength |
| 0 | 90 gsm | 14.4 | [symbol] | ∘ | [symbol] | ∘ |
| | paper | | | | | |
| 1 | 90 gsm | 14.22 | ● | ● | ● | [symbol] |
| | paper | | | | | |
| 2 | 90 gsm | 14.61 | ● | ● | ● | [symbol] |
| | paper | | | | | |
| | 90 gsm | 11.24 | ● | ● | ● | [symbol] |
| | paper | | | | | |
| | 65 gsm | 13.33 | ● | [symbol] | ● | [symbol] |
| | paper | | | | | |
| 3 | 90 gsm | 11.35 | n.t. | ● | ● | [symbol] |
| | paper | | | | | |
| 4 | 90 gsm | 15.5 | n.t. | [symbol] | [symbol] | n.t. |
| | paper | | | | | |
| 5 | 90 gsm | 15.4 | n.t | [symbol] | [symbol] | [symbol] |
| | paper | | | | | |
| 6 | 90 gsm | 16.6 | n.t. | [symbol] | [symbol] | n.t. |
| | paper | | | | | |

The results indicated that compositions 1 to 3 would be particularly suitable for use in HFFS or VFFS packages for heavy products. Composition 4 would be particularly suitable for use in HFFS or VFFS packages for medium-weight products. Compositions 5 and 6 would be suitable for use in HFFS or VFFS packages for light products.

### Example 7: Seal Curves

To illustrate the versatility of the adhesive compositions provided herein, seal curves were generated for some example compositions. A seal curve shows seal strength as a function of one of the sealing conditions (e.g., temperature, dwell time, or pressure) with the other two conditions staying constant. Detailed test conditions for each of the seal curves provided herein are provided further below.

Hot tack is a critical factor for industrial-scale packaging processes, which may require the bond to withstand forces (for example, to support the weight of a packaged product) while the adhesive is still warm. Thus, the rate at which hot tack builds to a useful strength is important. To this end, the hot tack seal curves reported herein include the hot tack value at 1 second after the seal formation and at 2 seconds after seal formation, in addition to the peak hot tack.

The sealing properties of compositions 7 to 15 as identified in Example 1 were investigated and seal curves were generated. To further illustrate how fast hot tack ramp up during the peeling of sealed sample, the hot tack values at 1 s of peeling motion and at 2 s of peeling motion were included in hot tack seal curves together with the peak hot tack values.

Seal initiation temperate (“SIT”) was measured in accordance with ASTM F2029-16 (2021), and is defined as the sealing temperature at which a heat seal of significant strength is produced. A “significant strength” in this context is a strength of at least 125 g/25 mm.

Minimum seal temperature (“MST”) is defined as the seal temperature necessary to obtain a bond strength of at least 200 g/25 mm, in accordance with common practice in the US packaging industry.

SIT and MST were calculated as follows, based on aged seal strength data:

$$( \frac{{V}_{0} - {V}_{1}}{{V}_{2} - {V}_{1}} ) \times {D}_{1} + {T}_{1} = S I T$$

or MST (Rounded to the nearest whole number)
where:
V₀ is the threshold seal strength value (125 g/25 mm for SIT, 200 g/25 mm for MST)
V₁=Seal value obtained prior to achieving V₀
V₂=Seal value obtained subsequent to achieving V₀
D₁=Increment used in seal temperature 10° F.
T₁=Temperature prior to achieving V₀

The test apparatus used for each of the experiments had a flat upper steel jaw and a flat lower polymer jaw. Seals were formed coated side to coated side.

### Composition 7 (a Comparative Example)

The properties of composition 7 were tested under the following conditions:
Substrate: 90 gsm kraft paper
Coat weight: 12 gsm
Seal pressure: 80 psi
Dwell time: 0.5 s
Peeling rate: 0.2 in/s

The SIT was 94° C. (201° F.).

The MST was 96° C. (205° F.).

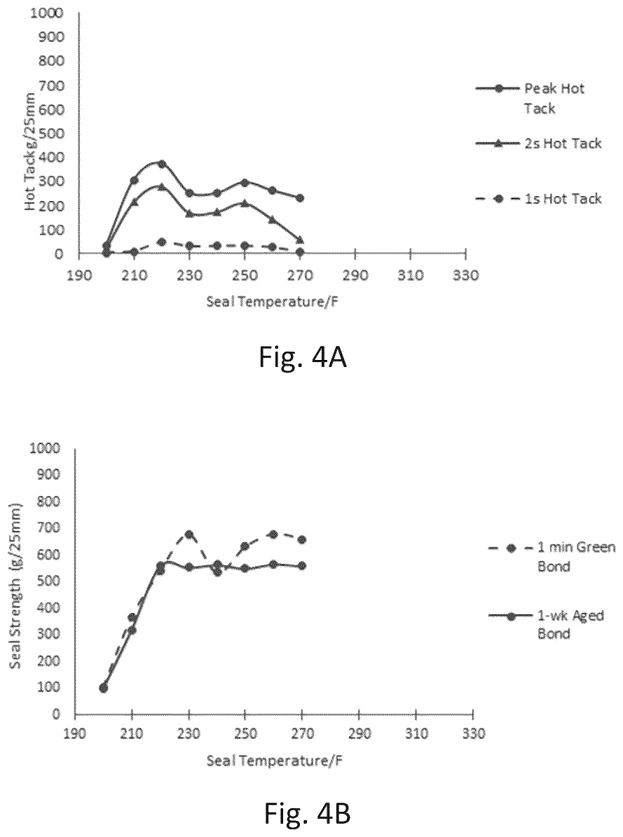

Hot tack and seal strength as a function of seal temperature for composition 7 under the conditions indicated above are shown in FIGS. 4A and 4B, respectively.

### Composition 8

The properties of composition 8 were tested under the following conditions:
Substrate: 90 gsm kraft paper
Coat weight: 10 gsm
Seal pressure: 80 psi
Dwell time: 0.5 s
Peeling rate: 0.2 in/s

The SIT was 96° C. (204° F.).

The MST was 99° C. (210° F.).

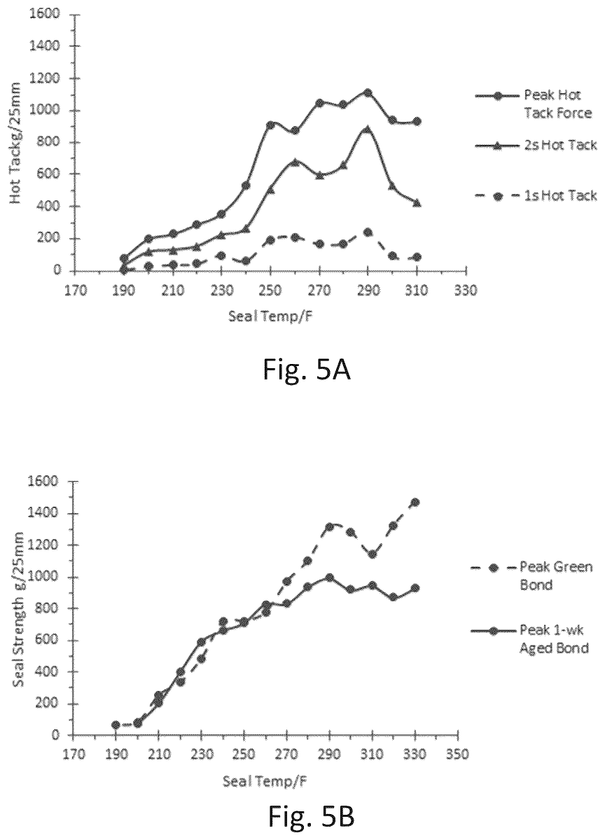

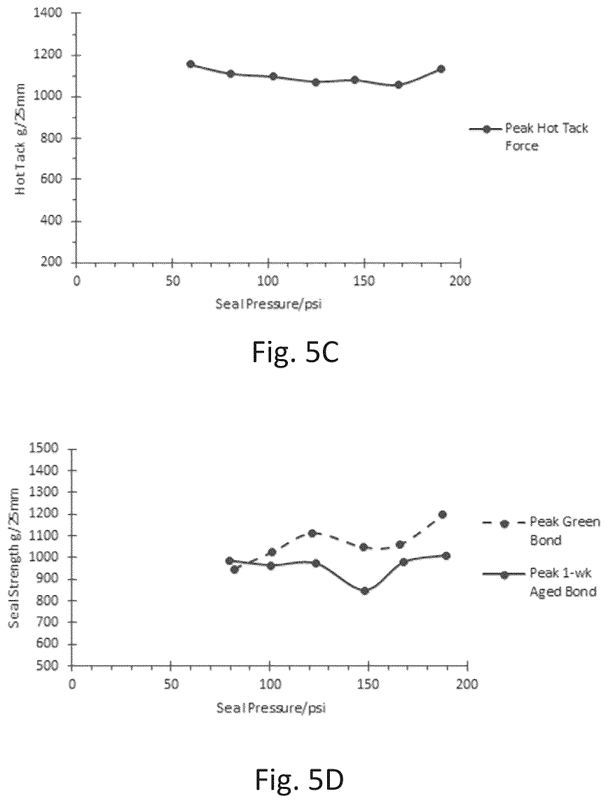

Hot tack and seal strength as a function of seal temperature for composition 8 under the conditions indicated above are shown in FIGS. 5A and 5B, respectively.

Hot tack and heat seal strength as a function of seal pressure were also investigated under the following conditions:
Substrate: 90 gsm kraft paper
Coat weight: 10 gsm
Seal temperature: 280° F.
Dwell time 0.5 s
Peeling rate: 0.2 in/s

The hot tack and heat seal strength results are shown in FIGS. 5C and 5D.

### Composition 9

The properties of composition 9 were tested under the following conditions:
Substrate: 33 gsm paper
Coat weight: 11 gsm
Seal pressure: 80 psi
Dwell time: 0.5 s
Peeling rate: 0.2 in/s

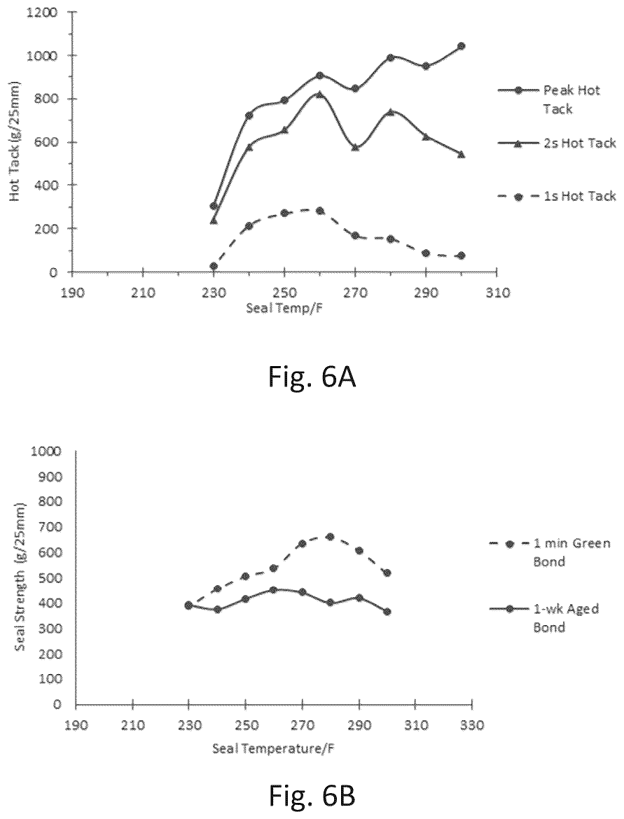

Hot tack and seal strength as a function of seal temperature is shown in FIG. 6A and FIG. 6B, respectively. The samples tested after seal strength all showed material failure which indicates the seals were stronger than the strength of the paper.

### Composition 10

The properties of composition 10 were tested under the following conditions:
Substrate: 33 gsm paper
Coat weight: 11 gsm
Seal pressure: 80 psi
Dwell time: 0.5 s
Peeling rate: 0.2 in/s

The SIT was 103° C. (217° F.).

The MST was 105° C. (221° F.).

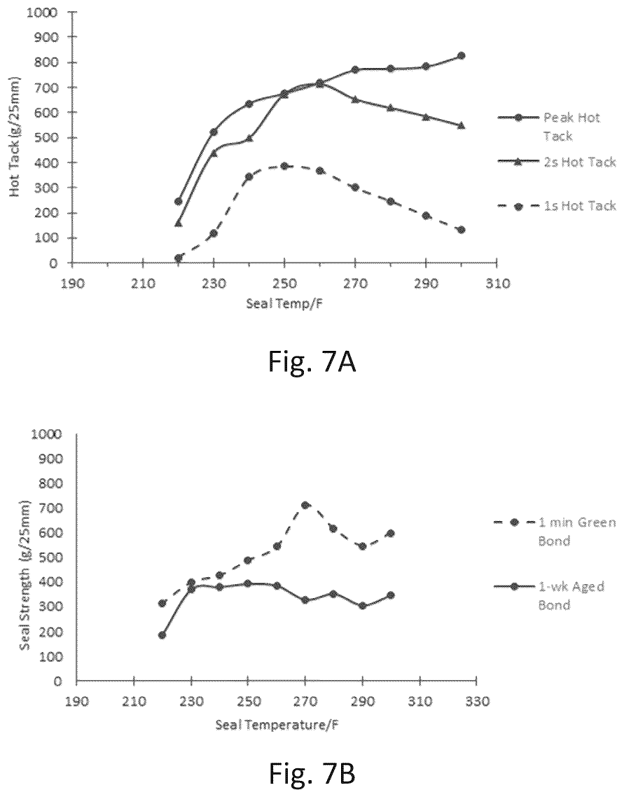

FIG. 7A shows hot tack as a function of seal temperature, and FIG. 7B shows seal strength as a function of seal temperature. Material failure was observed, indicating that the seals were stronger than the paper substrate.

### Composition 11

The properties of composition 11 were tested under the following conditions:
Substrate: 90 gsm paper
Coat weight: 13 gsm
Seal pressure: 80 psi
Dwell time: 0.5 s
Peeling rate: 0.2 in/s

The SIT was 95° C. (203° F.).

The MST was 96° C. (205° F.).

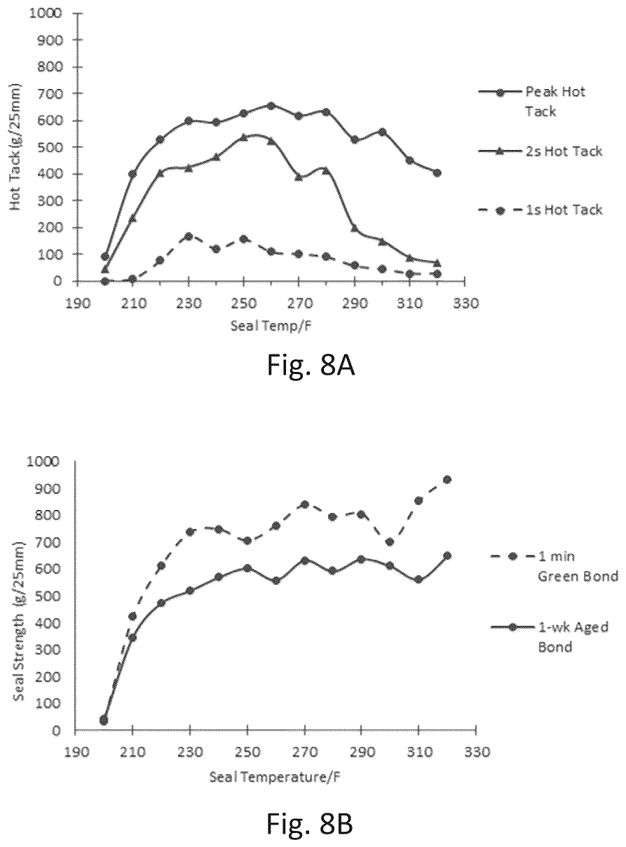

FIG. 8A shows hot tack as a function of seal temperature, and FIG. 8B shows seal strength as a function of seal temperature.

### Composition 12

The properties of composition 12 were tested under the following conditions:
Substrate: 90 gsm paper
Coat weight: 12 gsm
Seal pressure: 80 psi
Dwell time: 0.5 s
Peeling rate: 0.2 in/s

The SIT was 94° C. (202° F.).

The MST was 95° C. (203° F.).

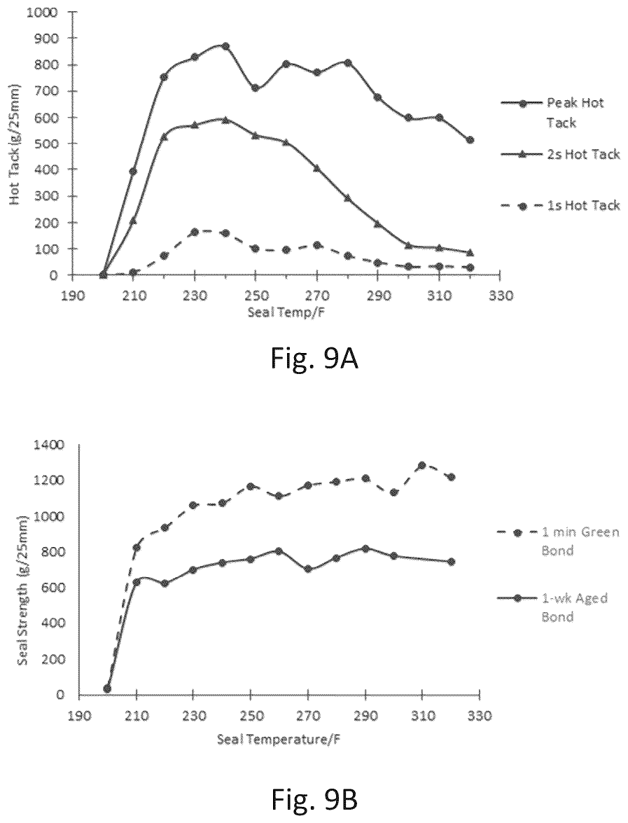

FIG. 9A shows hot tack as a function of seal temperature, and FIG. 9B shows seal strength as a function of seal temperature.

### Composition 13

The properties of composition 13 were tested under the following conditions:
Substrate: 90 gsm paper
Coat weight: 15 gsm
Seal pressure: 80 psi
Dwell time: 0.5 s
Peeling rate: 0.2 in/s

The MST was 95° C. (203° F.).

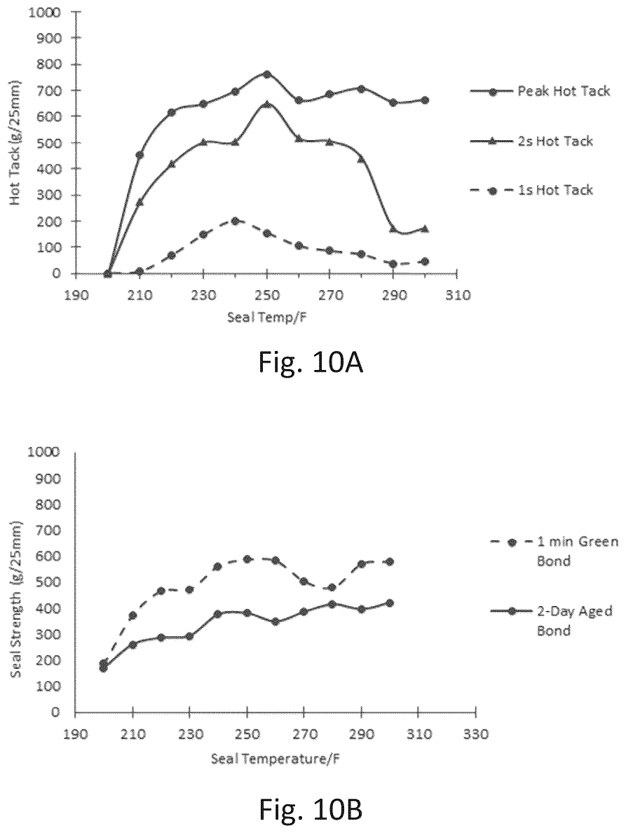

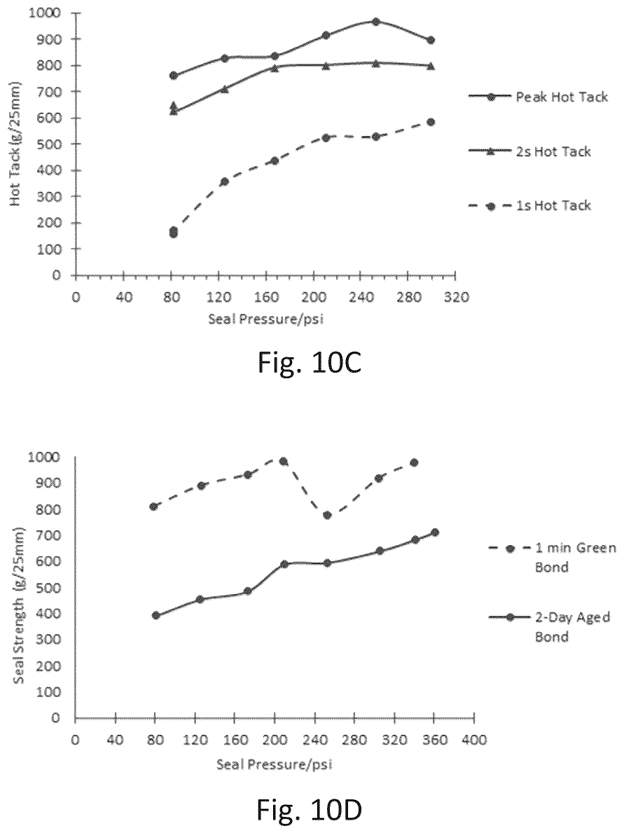

FIG. 10A shows hot tack as a function of seal temperature, and FIG. 10B shows seal strength as a function of seal temperature.

Hot tack and heat seal strength as a function of seal pressure were also investigated under the following conditions:
Substrate: 90 gsm kraft paper
Coat weight: 15 gsm
Seal temperature: 250° F.
Dwell time 0.5 s
Peeling rate: 0.2 in/s

The hot tack and heat seal strength results are shown in FIGS. 10C and 10D.

### Composition 14

The properties of composition 14 were tested under the following conditions:
Substrate: 90 gsm paper
Coat weight: 15 gsm
Seal pressure: 80 psi
Dwell time: 0.5 s
Peeling rate: 0.2 in/s

The MST was 96° C. (204° F.).

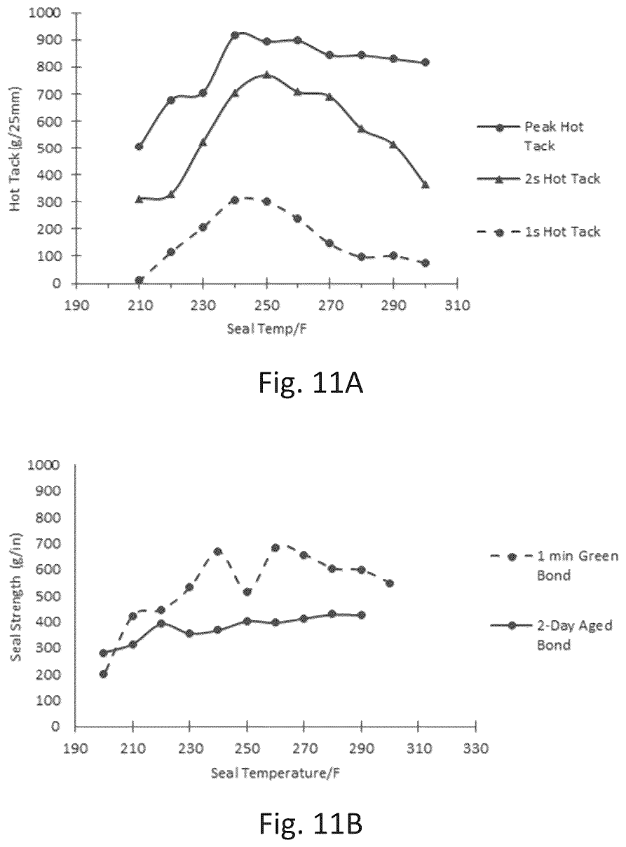

FIG. 11A shows hot tack as a function of seal temperature, and FIG. 11B shows seal strength as a function of seal temperature.

### Clauses

The present disclosure provides the following clauses:

Clause 1. A heat-sealable adhesive composition comprising a polyhydroxyalkanoate and a booster,
wherein the polyhydroxyalkanoate is present in an amount of at least 40%; and
wherein the booster is selected from:
   an acrylate-based polymer in an amount of 0.5 to 60%;
   a starch or modified starch in an amount of 0.1 to 30%;
   polyvinyl alcohol or ethylene-vinyl alcohol in an amount of 0.1 to 30%;
   a cellulose derivative in an amount of 0.1 to 10%;
   silica in an amount of 0.1 to 10%; and
   combinations thereof;
all percentages being by weight of the composition on a dry matter basis.

Clause 2. The composition according to Clause 1, wherein the booster is selected from the acrylate-based polymer, the cellulose derivative, the silica, and combinations thereof.

Clause 3. The composition according to Clause 1 or Clause 2, which is a biobased composition.

Clause 4. The composition according to any preceding Clause, which is recyclable and/or repulpable and/or biodegradable and/or compostable.

Clause 5. The composition according to any preceding Clause, wherein the polyhydroxyalkanoate is made up of residues of monomers selected from: hydroxybutyrate, hydroxyvalerate, hydroxyhexanoate, hydroxyoctanoate, hydroxydecanoate, and combinations thereof.

Clause 6. The composition according to Clause 5, wherein the polyhydroxyalkanoate comprises poly-3-hydroxybutyrate-co-3-hydroxyhexanoate.

Clause 7. The composition according to Clause 6, wherein the poly-3-hydroxybutyrate-co-3-hydroxyhexanoate comprises 80 to 95 mol % of hydroxybutyrate residues, the balance being hydroxyhexanoate residues.

Clause 8. The composition according to Clause 5, wherein the polyhydroxyalkanoate is a terpolymer.

Clause 9. The composition according to any preceding Clause, wherein the polyhydroxyalkanoate has a weight average molecular weight of 50,000 Daltons to 2.5 million Daltons, optionally 150,000 Daltons to 600,000 Daltons, further optionally 150,000 Daltons to 500,000 Daltons.

Clause 10. The composition according to any preceding Clause, wherein the polyhydroxyalkanoate is present in an amount of at least 45%.

Clause 11. The composition according to Clause 10, wherein the polyhydroxyalkanoate is present in an amount of 45 to 75%.

Clause 12. The composition according to Clause 11, wherein the polyhydroxyalkanoate is present in an amount of 45 to 65%.

Clause 13. The composition according to Clause 12, wherein the polyhydroxyalkanoate is present in an amount of 45 to 55%.

Clause 14. The composition according to Clause 13, wherein the polyhydroxyalkanoate is present in an amount of 48 to 52%.

Clause 15. The composition according to Clause 10, wherein the polyhydroxyalkanoate is present in an amount of at least 70%.

Clause 16. The composition according to Clause 15, wherein the polyhydroxyalkanoate is present in an amount of at least 80%.

Clause 17. The composition according to Clause 16, wherein the polyhydroxyalkanoate is present in an amount of at least 90%.

Clause 18. The composition 17, wherein the polyhydroxyalkanoate is present in an amount of 94 to 98%.

Clause 19. The composition according to any preceding Clause, comprising the acrylate-based polymer in an amount of 1 to 50%, optionally 5 to 50%.

Clause 20. The composition according to Clause 19, comprising the acrylate-based polymer in an amount of 25 to 50%.

Clause 21. The composition according to Clause 20, comprising the acrylate-based polymer in an amount of 35 to 50%.

Clause 22. The composition according to Clause 21, comprising the acrylate-based polymer in an amount of 45 to 50%.

Clause 23. The composition according to Clause 22, comprising the acrylate-based polymer in an amount of 48 to 50%.

Clause 24. The composition according to any preceding Clause, wherein the acrylate-based polymer has a viscosity of less than or equal to 1,000 mPa·s as measured at 23° C. using a Brookfield RV viscometer with a #3 spindle operating at 100 rpm when the acrylate-based polymer is dispersed or suspended in water to form an aqueous dispersion, suspension, or emulsion having a solids content in the range 30 to 60% by total weight of the aqueous dispersion, suspension, or emulsion.

Clause 25. The composition according to any preceding Clause, further comprising a wax in an amount of 0.01 to 5%, optionally 0.01 to 1%.

Clause 26. The composition according to Clause 25, wherein the wax is a plant-based wax, optionally selected from palm oil-based wax, coconut oil-based wax, candelilla wax, carnauba wax, rice bran wax, soybean wax, sugar cane wax, sunflower wax, canola wax, rapeseed wax, and mixtures thereof.

Clause 27. The composition according to Clause 26, wherein the wax is selected from palm oil-based wax, coconut oil-based wax, and mixtures thereof.

Clause 28. The composition according to any preceding Clause, comprising the cellulose derivative in an amount of 0.5 to 6%.

Clause 29. The composition according to Clause 28, comprising the cellulose derivative in an amount of 1 to 3%.

Clause 30. The composition according to any preceding Clause, wherein the cellulose derivative is a cellulose ether or a cellulose ester.

Clause 31. The composition according to Clause 30, wherein the cellulose derivative is a cellulose ether bearing substituents selected from alkyl groups, hydroxyalkyl groups, carboxyalkyl groups, and combinations thereof.

Clause 32. The composition according to Clause 31, wherein the cellulose ether is selected from:
alkyl celluloses, such as methyl cellulose or ethyl cellulose;
hydroxyalkylcelluloses, such as hydroxymethyl cellulose or hydroxyethylcellulose;
carboxyalkylcelluloses, such as carboxymethylcellulose.

Clause 33. The composition according to Clause 32, wherein the cellulose ether is methyl cellulose.

Clause 34. The composition according to Clause 32, wherein the cellulose ether is hydroxypropylmethyl cellulose.

Clause 35. The composition according to Clause 34, wherein the hydroxypropylmethyl cellulose is present in an amount of 0.1 to 0.5%, optionally 0.3 to 0.4%.

Clause 36. The composition according to any preceding Clause wherein, when dissolved in water at a concentration of 2% by weight, the cellulose derivative has a viscosity in the range 3 to 10,000 mPa·s as measured at 23° C. using a Brookfield RV viscometer with a #3 spindle operating at 100 rpm.

Clause 37. The composition according to any of Clauses 28 to 36, comprising the acrylate-based polymer in an amount of 0.5 to 10%.

Clause 38. The composition according to any of Clauses 28 to 37, comprising the acrylate-based copolymer in an amount of 25 to 45%, optionally 25 to 35% or 35 to 45%.

Clause 39. The composition according to any preceding Clause, comprising the starch or modified starch in an amount of 3 to 18%, optionally 3 to 12%, further optionally 5 to 7%.

Clause 40. The composition according to any preceding Clause, comprising the polyvinyl alcohol or ethylene-vinyl alcohol in an amount of 3 to 18%, optionally 3 to 12%, further optionally 5 to 7%.

Clause 41. The composition according to any preceding Clause, further comprising a clay in an amount of 0.1 to 10%, optionally 1 to 10%, further optionally 3 to 8% or about 5%.

Clause 42. The composition according to any preceding Clause, comprising silica in an amount of 2 to 8%.

Clause 43. The composition according to Clause 42, comprising silica in an amount of 3 to 7%.

Clause 44. The composition according to Clause 43, comprising silica in an amount of 4 to 6%.

Clause 45. The composition according to any preceding Clause, further comprising an effective amount of one or more additives selected from a pH adjuster, a rheology modifier, an anti-block agent, an anti-slip agent, a defoamer, a biocide, a surfactant, and a plasticizer.

Clause 46. The composition according to any preceding Clause, which has a peak hot tack of at least 300 g/25 mm, the peak hot tack being measured in accordance with test method B of ASTM F1921/F1921M-12 (2018) using a sealing temperature of 90 to 180° C., a seal pressure of 40 to 350 psi, and a dwell time of 0.01 to 2 s.

Clause 47. The composition according to Clause 46, which has a peak hot tack of at least 500 g/25 mm.

Clause 48. The composition according to any preceding Clause, which is in the form of a bond.

Clause 49. The composition according to Clause 48, wherein the bond has a peak green bond strength of at least 300 g/25 mm as measured in accordance with Technique B of ASTM F88/F88M-23, the green bond strength being measured minute after forming the bond, using a sealing temperature of 90 to 180° C., a seal pressure of 40 to 350 psi, and a dwell time of 0.01 to 2 s.

Clause 50. The composition according to Clause 49, wherein the bond has a peak green bond strength of at least 500 g/25 mm, and optionally at least 800 g/25 mm as measured in accordance with Technique B of ASTM F88/F88M-23, the green bond strength being measured 1 minute after forming the bond.

Clause 51. The composition according to any of Clauses 48 to 50, wherein the bond has a peak aged bond strength of at least 300 g/25 mm, optionally at least 400 g/25 mm, further 600 g/25 mm, further optionally at least 750 g/25 mm as measured in accordance with Technique B of ASTM F88/F88M-23, the aged bond strength being measured 48 hours after forming the bond, using a sealing temperature of 90 to 180° C., a seal pressure of 40 to 350 psi, and a dwell time of 0.01 to 2 s.

Clause 52. An aqueous dispersion of the composition according to any of Clauses 1 to 47.

Clause 53. The aqueous dispersion according to Clause 52, having a pH of at least 6.

Clause 54. The aqueous dispersion according to Clause 53, having a pH in the range 7.5 to 8.5, optionally 7.8 to 8.5.

Clause 55. The aqueous dispersion according to any of Clauses 52 to 54, having a solids content in the range 30 to 50% by total weight of the aqueous dispersion.

Clause 56. The aqueous dispersion according to any of Clauses 52 to 55, having a viscosity in the range 100 to 1,000 mPa·s as measured at 23° C. using a Brookfield RV viscometer with a #3 spindle operating at 100 rpm.

Clause 57. Packaging comprising a substrate and a heat-sealable adhesive composition as defined in any of Clauses 1 to 51.

Clause 58. The packaging according to Clause 57, wherein the substrate comprises a cellulosic substrate, such as paper, paperboard, cardboard, or moulded fibre.

Clause 59. The packaging according to Clause 57 or Clause 58, wherein the substrate comprises a textile or a polymer film, optionally a biobased polymer film.

Clause 60. The packaging according to any of Clauses 57 to 59, further comprising a barrier layer, wherein the heat-sealable adhesive composition is arranged over the barrier layer, optionally wherein the barrier layer is selected from a metal layer, a water barrier, a water vapor barrier, a gas barrier, an aroma barrier, an oil and grease resistant barrier, and combinations thereof.

Clause 61. The packaging according to any of Clauses 57 to 60, further comprising a printed layer, optionally wherein the heat-sealable adhesive composition is arranged on the printed layer.

Clause 62. The packaging according to any of Clauses 57 to 61, wherein the heat-sealable adhesive composition is in the form of a layer over the substrate.

Clause 63. The packaging according to Clause 62, having a laminated structure wherein the layer of the heat-sealable adhesive composition is interposed between the substrate and a further layer.

Clause 64. The packaging according to any of Clauses 57 to 63, wherein the heat-sealable adhesive is configured for sealing closed the packaging.

Clause 65. The packaging according to any of Clauses 57 to 64, which is in the form of a flexible package such as bag, pouch, sachet, flow wrap, or flexible lid.

Clause 66. The packaging according to any of Clauses 57 to 65, wherein the packaging is configured for filling and sealing using a packaging machine; optionally a packaging machine selected from a horizontal form fill seal packaging machine; a vertical form fill seal packaging machine; and a pouch making machine; further optionally a horizontal or vertical form fill seal packaging machine.

Clause 67. Use of a booster to improve the hot tack and/or heat seal strength of a heat-sealable adhesive composition,
wherein the heat-sealable adhesive composition is as defined in any of Clauses 1 to 55.

Clause 68. Use according to Clause 67, wherein the booster increases the rate at which hot tack ramps up.

Clause 69. Use according to Clause 67 or Clause 68, wherein the heat seal strength is a green heat seal strength and/or an aged heat seal strength.

Clause 70. Use according to any of Clauses 67 to 69, wherein the booster improves the heat seal strength by at least 5%, optionally at least 10%.

Clause 71. A method of forming a bond using a heat-sealable adhesive composition as defined in any of Clauses 1 to 47, which method comprises:
arranging the heat-sealable adhesive composition between first and second regions to be bonded, such that the first and second regions are each in contact with the heat-sealable adhesive composition;
applying heat to the heat-sealable adhesive composition; and applying pressure to the heat-sealable adhesive composition;
wherein applying the heat and the pressure causes the heat-sealable adhesive composition to form the bond between the first and second regions.

Clause 72. The method according to Clause 71, wherein the heat and pressure are applied simultaneously.

Clause 73. The method according to Clause 72, wherein the heat is applied before the pressure.

Clause 74. The method according to any of Clause 71 to 73, further comprising applying ultrasound to the heat-sealable adhesive composition.

Clause 75. The method according to any of Clauses 71 to 74, wherein applying the heat and the pressure causes the booster to improve the hot tack of the adhesive composition as measured in accordance with ASTM F1921/F1921M-12 (2023).

Clause 76. The method according to any of Clauses 71 to 75, wherein applying the heat and the pressure cause the booster to improve the heat seal strength of the bond as measured in accordance with ASTM F88/F88M-23.

Clause 77. The method according to any of Clauses 71 to 76, further comprising, before the arranging, applying the heat-sealable adhesive composition to at least one of the first and second surfaces.

Clause 78. The method according to Clause 77, wherein the heat-sealable adhesive composition is applied in the form of an aqueous dispersion as defined in any of claims 52 to 56.

Clause 79. The method according to Clause 77 or Clause 78, wherein the applying comprises rod coating, blade coating, flexographic coating, gravure coating, spray coating, curtain coating, or air-knife coating.

Clause 80. The method according to any of Clauses 71 to 79, wherein the heat and pressure are applied using packaging machine, such as a packaging machine selected from a horizontal form fill seal packaging machine; a vertical form fill seal packaging machine; and a pouch making machine.

Clause 81. The method according to any of Clauses 71 to 80, wherein the heat and/or the pressure is applied for a dwell time of at least 0.01 seconds.

Clause 82. The method according to Clause 81, wherein the pressure is applied for a dwell time of 0.1 to 1 seconds, optionally 0.25 to 0.75 seconds, further optionally about 0.5 seconds.

Clause 83. The method according to any of Clauses 71 to 82, wherein applying the heat comprises heating the adhesive composition to a temperature of at least 90° C., and optionally a temperature of 110 to 160° C., further optionally 130 to 160° C.

Clause 84. The method according to any of Clauses 71 to 83, wherein applying the pressure comprises applying a pressure of at least 40 psi, and optionally at least 80 psi.

Clause 85. The method according to Clause 83, wherein applying the pressure comprises applying a pressure of at least 40 psi, optionally 50 to 600 psi, further optionally 150 to 390 psi, further optionally 175 to 225 psi, or about 200 psi.

It will be appreciated that the above embodiments have been described by way of example only.

Other variants or use cases of the disclosed techniques may become apparent to the person skilled in the art once given the disclosure herein. The scope of the disclosure is not limited by the described embodiments but only by the accompanying claims.

1. A heat-sealable adhesive composition comprising a polyhydroxyalkanoate and a booster,
wherein the polyhydroxyalkanoate is present in an amount of at least 40%; and
wherein the booster is selected from:
an acrylate-based polymer in an amount of 0.5 to 60%;
a starch or modified starch in an amount of 0.1 to 30%;
polyvinyl alcohol or ethylene-vinyl alcohol in an amount of 0.1 to 30%;
a cellulose derivative in an amount of 0.1 to 10%;
silica in an amount of 0.1 to 10%; and
combinations thereof;
all percentages being by weight of the composition on a dry matter basis.

2. The composition according to claim 1, which is a biobased composition.

3. The composition according to claim 1, wherein the polyhydroxyalkanoate comprises or consists of residues of monomers selected from: hydroxybutyrate, hydroxyvalerate, hydroxyhexanoate, hydroxyoctanoate, hydroxydecanoate, and combinations thereof.

4. The composition according to claim 3, wherein the polyhydroxyalkanoate comprises poly-3-hydroxybutyrate-co-3-hydroxyhexanoate.

5. The composition according to claim 1, wherein the polyhydroxyalkanoate is present in an amount of 45 to 55%.

6. The composition according to claim 1, wherein the polyhydroxyalkanoate is present in an amount of 94 to 98%.

7. The composition according to claim 1, comprising the acrylate-based polymer in an amount of 45 to 50%.

8. The composition according to claim 7, further comprising a wax in an amount of 0.01 to 5%.

9. The composition according to claim 1, comprising the cellulose derivative in an amount of 0.5 to 6%.

10. The composition according to claim 9, wherein the cellulose derivative is a cellulose ether selected from: alkyl celluloses, hydroxyalkylcelluloses, and carboxyalkylcelluloses.

11. The composition according to claim 10, wherein the cellulose derivative is hydroxypropylmethyl cellulose and is present in an amount of 0.1 to 0.5%.

12. The composition according to claim 1, comprising the acrylate-based polymer in an amount of 0.5 to 10%.

13. The composition according to claim 1, comprising the acrylate-based copolymer in an amount of 25 to 45%.

14. The composition according to claim 1, comprising the starch or modified starch in an amount of 3 to 18%.

15. The composition according to claim 1, comprising the polyvinyl alcohol or ethylene-vinyl alcohol in an amount of 3 to 18%.

16. The composition according to claim 15, further comprising a clay in an amount of 0.1 to 10%.

17. The composition according to claim 1, comprising silica in an amount of 2 to 8%.

18. The composition according to claim 1, further comprising an effective amount of one or more additives selected from a pH adjuster, a rheology modifier, an anti-block agent, an anti-slip agent, a defoamer, a biocide, a surfactant, and a plasticizer.

19. An aqueous dispersion of the composition according to claim 1, the aqueous dispersion having a pH in the range 7.5 to 8.5, and having a solids content in the range 30 to 50% by total weight of the aqueous dispersion.

20. Packaging comprising a substrate and a heat-sealable adhesive composition as defined in claim 1, wherein the substrate comprises a cellulosic substrate, a textile, or a polymer film.
